(19) United States
(12) Patent Application Publication
(10) Pub. No.: US 2026/0277383 A1
(43) Pub. Date: Sep. 17, 2026

(54) DISPLAY METHOD, NON-TRANSITORY COMPUTER-READABLE STORAGE MEDIUM STORING PROGRAM, AND SIMULATION DEVICE

(71) Applicant: SEIKO EPSON CORPORATION, Tokyo (JP)

(72) Inventor: Mayo SUZUKA, MATSUMOTO-SHI (JP)

(21) Appl. No.: 19/563,958

(22) Filed: Mar. 11, 2026

(30) Foreign Application Priority Data
Mar. 13, 2025 (JP) 2025-040056

(51) Int. Cl. G06F 3/04815; B25J 9/16

(52) U.S. Cl. CPC G06F 3/04815; B25J 9/1605

(57) ABSTRACT

A display method includes a display step of setting, for a three-dimensional virtual space in which a virtual device is disposed, a viewpoint and a line-of-sight direction for viewing the virtual space, and displaying, a simulation image when the virtual space is viewed from the viewpoint in the line-of-sight direction, a reception step of displaying, on the display section, a plurality of setting methods for setting a position of a rotation center in the virtual space, and receiving a selection of the setting method for the position of the rotation center from among the plurality of displayed setting methods, and a change step of setting the position of the rotation center based on the selected setting method, and rotating the viewpoint and the line-of-sight direction around the rotation center in response to an operation of an input section to change the display of the virtual space in the simulation image.

### CROSS-REFERENCE TO RELATED APPLICATIONS

The present application is based on, and claims priority from JP Application Serial Number 2025-040056, filed Mar. 13, 2025, the disclosure of which is hereby incorporated by reference herein in its entirety.

### BACKGROUND OF THE INVENTION

### 1. Technical Field

The present disclosure relates to a display method, a non-transitory computer-readable storage medium storing a program, and a simulation device.

### 2. Related Art

JP-A-2005-20748 discloses a method in which a video captured by a camera installed in a remote location is displayed on a display, and the camera is rotated using a joystick while checking the video on the display.

Incidentally, there are cases where it is desired to display a simulation image of a virtual space in which a virtual device simulating a device is disposed on a display section such as a display, and to simulate a shape, a disposition, or an operation of the device, or internal or external phenomena of the device. In this case, as in JP-A-2005-20748, there is a demand for rotating a viewpoint when viewing the virtual space and a line-of-sight direction (view direction), which is a direction in which the virtual space is viewed from the viewpoint, in response to a user operation.

In particular, in simulation images, there are cases where it is desired to check various locations of the virtual space in various directions, and when the position of the rotation center when rotating the viewpoint and the line-of-sight direction is always in the same position, it becomes difficult to perform the operations required to obtain a desired simulation image, resulting in the problem that the desired simulation image cannot be acquired efficiently.

### SUMMARY OF THE INVENTION

According to an application example of the present disclosure, there is provided a display method including: a display step of setting, for a three-dimensional virtual space in which a virtual device simulating a device is disposed, a viewpoint and a line-of-sight direction for viewing the virtual space from the viewpoint, and displaying, on a display section, a simulation image when the virtual space is viewed from the viewpoint in the line-of-sight direction; a reception step of displaying, on the display section, a plurality of setting methods for setting a position of a rotation center in the virtual space, and receiving a selection of the setting method for the position of the rotation center from among the plurality of displayed setting methods; and a change step of setting the position of the rotation center based on the selected setting method, and rotating the viewpoint and the line-of-sight direction around the rotation center in response to an operation of an input section to change the display of the virtual space in the simulation image.

According to another application example of the present disclosure, there is provided a non-transitory computer-readable storage medium storing a program, the program causing a computer to execute: a display process of setting, for a three-dimensional virtual space in which a virtual device simulating a device is disposed, a viewpoint and a line-of-sight direction for viewing the virtual space from the viewpoint, and displaying, on a display section, a simulation image when the virtual space is viewed from the viewpoint in the line-of-sight direction; a reception process of displaying, on the display section, a plurality of setting methods for setting a position of a rotation center in the virtual space, and receiving a selection of the setting method for the position of the rotation center from among the plurality of displayed setting methods; and a change process of setting the position of the rotation center based on the selected setting method, and rotating the viewpoint and the line-of-sight direction around the rotation center to change the display of the virtual space in the simulation image.

According to still another application example of the present disclosure, there is provided a simulation device including: a display section; an input section; a display control section that sets, for a three-dimensional virtual space in which a virtual device simulating a device is disposed, a viewpoint and a line-of-sight direction for viewing the virtual space from the viewpoint, and displays, on the display section, a simulation image when the virtual space is viewed from the viewpoint in the line-of-sight direction; and a reception section that displays, on the display section, a plurality of setting methods for setting a position of a rotation center in the virtual space, and receives a selection of the setting method for the position of the rotation center from among the plurality of displayed setting methods by operating the input section, in which the display control section sets the position of the rotation center based on the selected setting method, and rotates the viewpoint and the line-of-sight direction around the rotation center to change the display of the virtual space in the simulation image.

### BRIEF DESCRIPTION OF DRAWINGS

FIG. 1 is a schematic diagram showing a robot system including a simulation device according to an embodiment of the present disclosure.

FIG. 2 is a block diagram showing the robot system of FIG. 1.

FIG. 3 is a plan view schematically showing a relationship between a virtual space in which a virtual robot simulating a robot of FIG. 1 is disposed, and a viewpoint, a line-of-sight direction, a field of view, a rotation center, a world coordinate system, a local coordinate system, and a tool coordinate system.

FIG. 4 is a screen on which a simulation image of a virtual space in an initial state is displayed.

FIG. 5 is a screen on which the simulation image at a first position before the viewpoint shown in FIG. 3 is rotated is displayed.

FIG. 6 is a simulator setting screen.

FIG. 7 is a Click Point setting screen.

FIG. 8 is a screen showing a state in which the rotation center is set on an upper surface of a virtual workpiece under a cursor, following the state in FIG. 5.

FIG. 9 is a screen on which the simulation image at a second position after the viewpoint shown in FIG. 3 has been rotated is displayed.

FIG. 10 is a screen showing a state in which the rotation center is set at a position in the virtual space in which there is no virtual workpiece, following the state shown in FIG. 5.

FIG. 11 is a schematic diagram showing that the appearance of the virtual workpiece viewed from a viewpoint camera in a case where the viewpoint camera is rotated varies depending on a distance between the rotation center and the virtual workpiece.

FIG. 12 is a flowchart showing a display method according to an embodiment of the present disclosure.

### DETAILED DESCRIPTION OF THE INVENTION

Hereinafter, embodiments of the present disclosure will be described with reference to the drawings. The following description does not limit the technical range or the meaning of the terms described in the claims. In addition, the dimensional ratios of the drawings are exaggerated for convenience of description and may be different from the actual ratios.

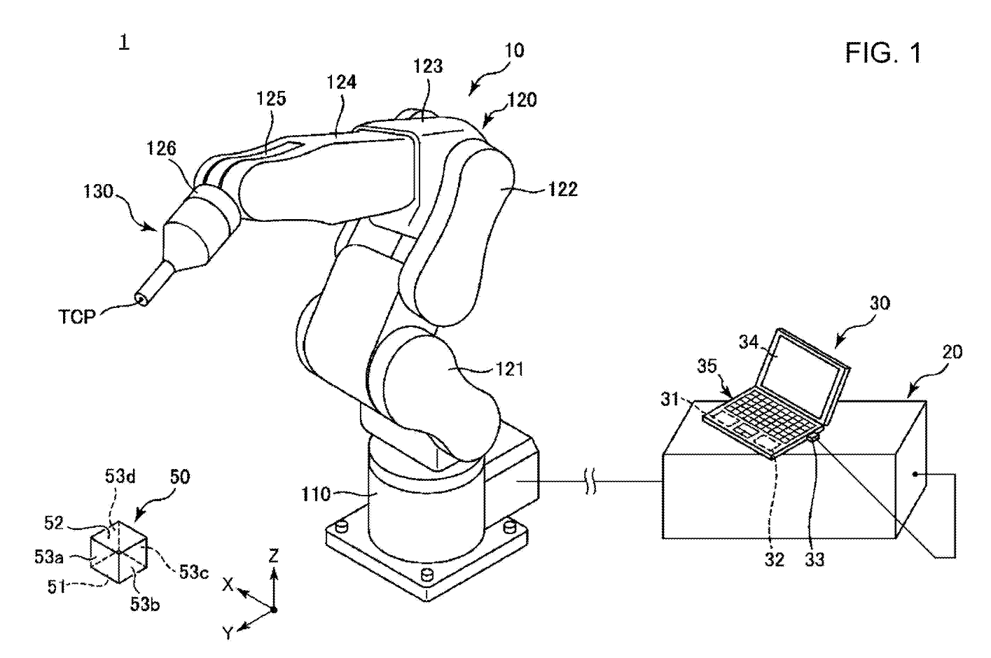

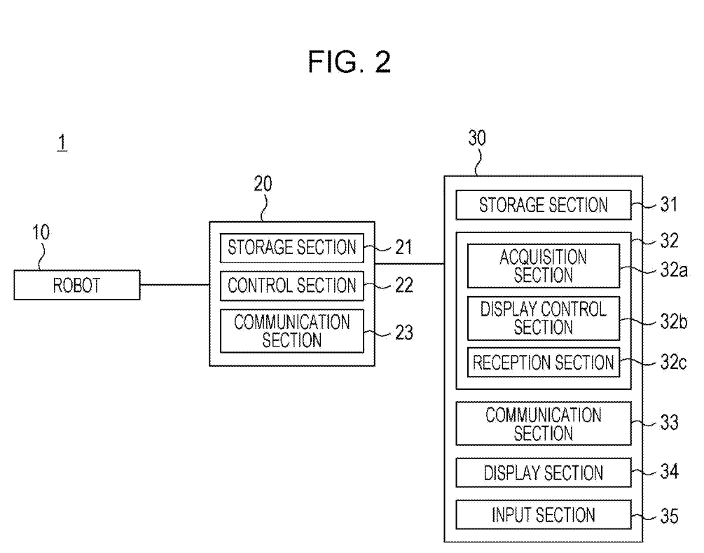

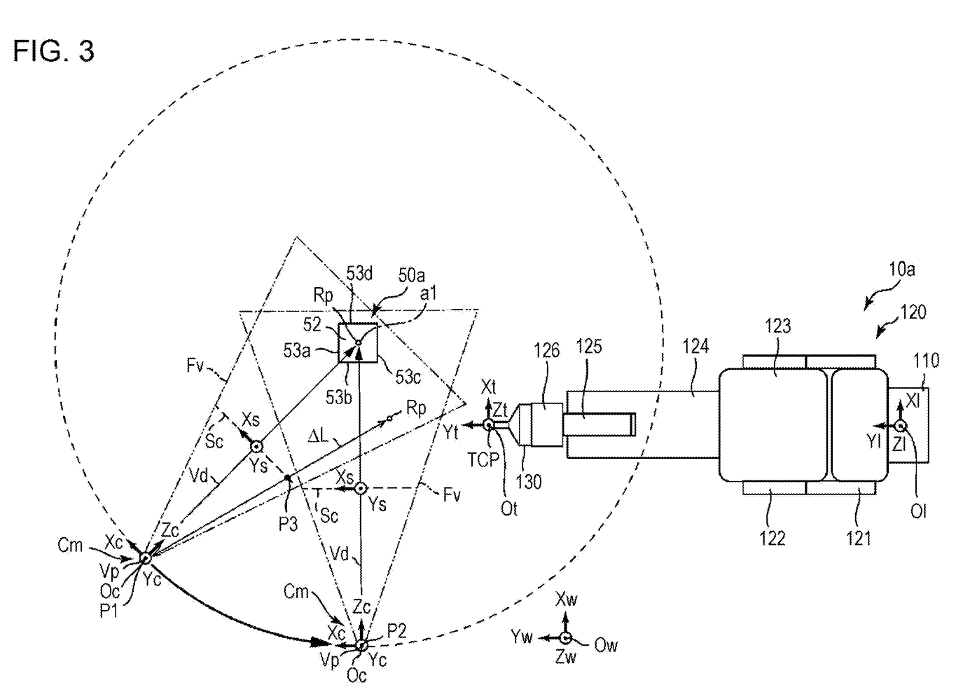

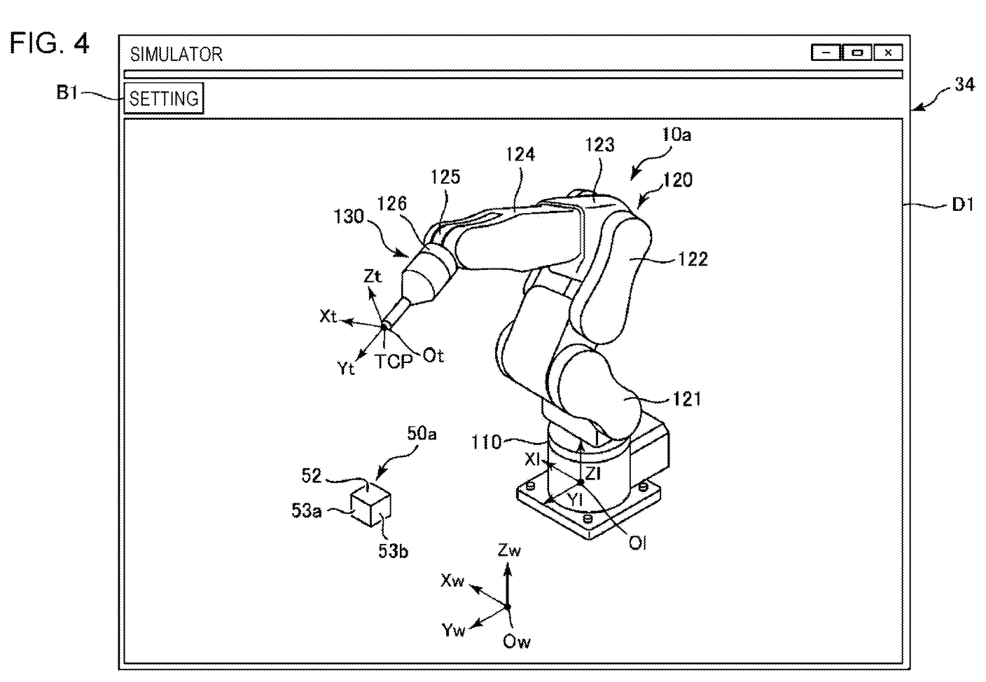

FIG. 1 is a schematic diagram showing a robot system 1 including a simulation device 30 according to the present embodiment. FIG. 2 is a block diagram showing the robot system 1 of FIG. 1. FIG. 3 is a plan view schematically showing a relationship between a virtual space in which a virtual robot 10a simulating a robot 10 in FIG. 1 is disposed, and a viewpoint Vp, a line-of-sight direction Vd, a field of view Fv, a rotation center Rp, a world coordinate system (Xw, Yw, Zw), a local coordinate system (Xl, Yl, Zl), and a tool coordinate system (Xt, Yt, Zt). FIG. 4 is a screen on which a simulation image D1 of a virtual space in an initial state is displayed.

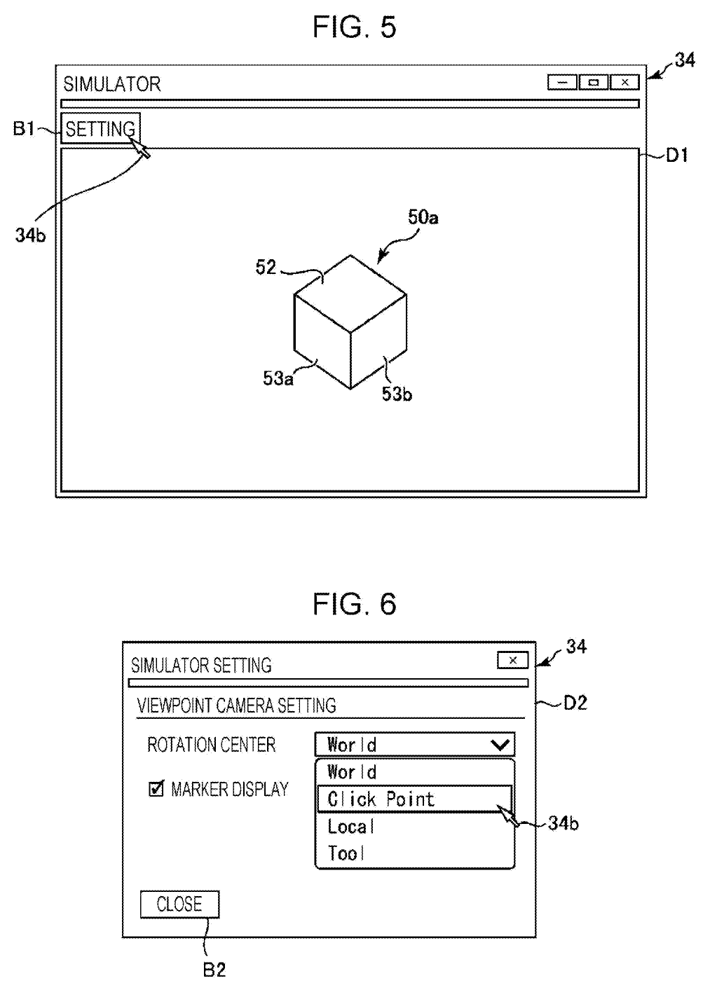

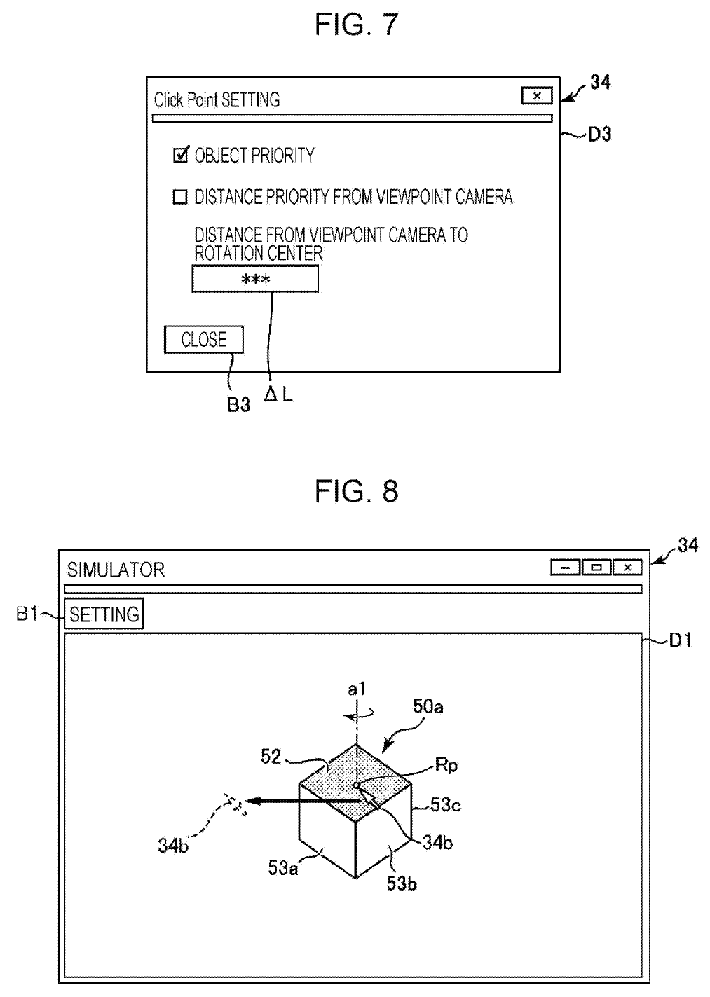

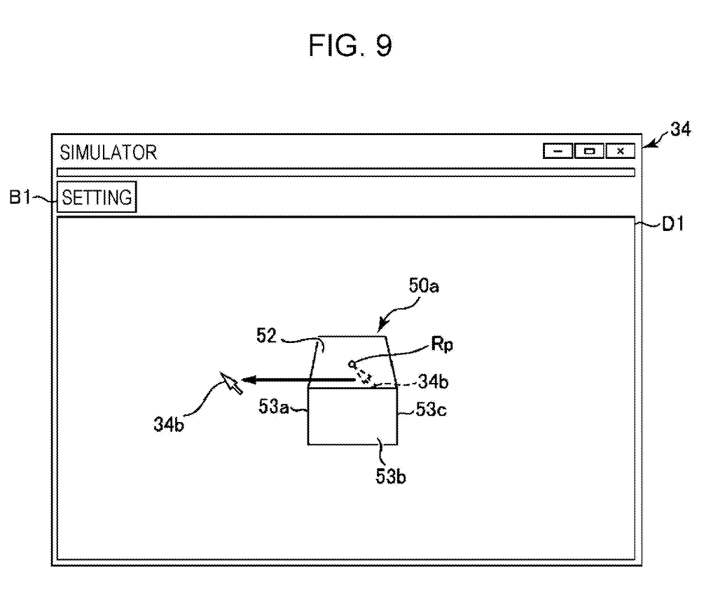

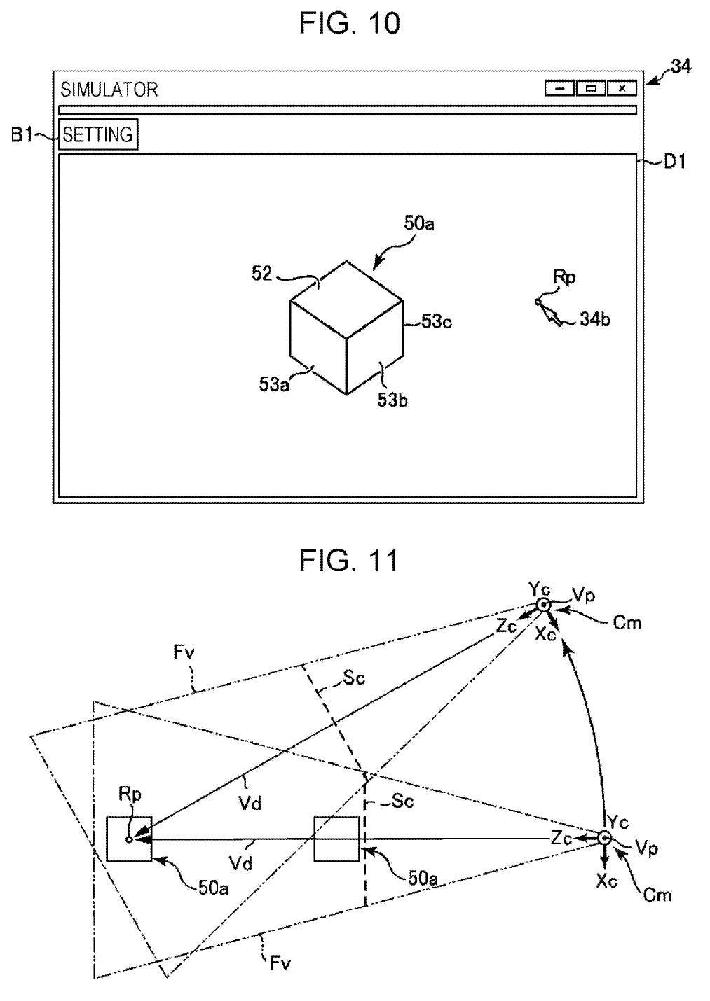

FIG. 5 is a screen on which the simulation image D1 at a first position P1 before the viewpoint Vp shown in FIG. 3 is rotated is displayed. FIG. 6 shows a simulator setting screen D2. FIG. 7 shows a Click Point setting screen D3. FIG. 8 is a screen showing a state in which the rotation center Rp is set on an upper surface 52 of a virtual workpiece 50a under a cursor 34b, following the state in FIG. 5. FIG. 9 is a screen on which the simulation image D1 at a second position P2 after the viewpoint Vp shown in FIG. 3 has been rotated is displayed. FIG. 10 is a screen showing a state in which the rotation center Rp is set at a position in the virtual space in which there is no virtual workpiece 50a, following the state shown in FIG. 5. FIG. 11 is a schematic diagram showing that the appearance of the virtual workpiece 50a viewed from a viewpoint camera Cm in a case where the viewpoint camera Cm is rotated varies depending on a distance between the rotation center Rp and the virtual workpiece 50a.

In FIG. 1, an X-axis, a Y-axis, and a Z-axis are set as three mutually orthogonal axes for a work space in which a robot 10, which will be described later, is disposed. Each axis is represented by an arrow, with the tip end of the arrow being the “positive side” and the base end of the arrow being the “negative side”. In the following description, for example, an “X-axis direction” includes both the positive direction and the negative direction of the X-axis. The same applies to a Y-axis direction and a Z-axis direction. Further, in the following description, particularly, the positive side in the Z-axis direction will be referred to as “upper” and the negative side in the Z-axis direction will be referred to as “lower”. The Z-axis does not need to be parallel to a vertical direction, and may be inclined relative to the vertical direction.

The simulation device 30 according to the present embodiment is a device that generates a simulation image D1 of a three-dimensional virtual space in which a three-dimensional virtual device simulating a device is disposed, as shown in FIG. 4, and displays the simulation image D1 on a display section 34. In the following, an example will be described in which the device for which the simulation image D1 is generated is the robot 10 and the simulation device 30 is incorporated into the robot system 1.

The robot system 1, when outlined with reference to FIGS. 1 and 2, includes the robot 10, a control device 20, and the simulation device 30. Each section of the robot system 1 will be described in detail below.

First, the robot 10 will be described.

The robot 10 is an industrial single-arm, six-axis vertical articulated robot, as shown in FIG. 1. However, the type of robot 10 is not limited to the above, and may be, for example, a double-arm articulated robot, a horizontal articulated robot, or a mobile robot. In the present embodiment, the robot 10 includes a base 110 and a robot arm 120.

The base 110 is a support body that supports the robot arm 120. The base 110 is fixed to, for example, the floor, the ceiling, or the like of a factory.

The robot arm 120 has an arm 121, an arm 122, an arm 123, an arm 124, an arm 125, and an arm 126. Hereinafter, these will be referred to as “arms 121 to 126”. The arm 121 is disposed above the base 110 and is rotatably coupled to the base 110. The plurality of arms 121 to 126 are coupled in this order from the base end to the tip end. Each of the arms 121 to 126 is rotatably coupled to the adjacent arm.

The robot 10 further includes a driving portion (not shown) that rotationally drives each of the arms 121 to 126. Each driving portion includes a motor that generates a driving force to rotationally drive the corresponding arm, a reducer that reduces the output of the motor, a motor driver that drives the motor, an angle detector that detects the amount of rotation of the motor, and the like. Each driving portion is electrically coupled to the control device 20 via the base 110.

A tool (end effector) 130 can be attached to the tip end portion of the robot arm 120, that is, the tip end portion of the arm 126. The tool 130 may or may not be a component of the robot 10. The robot 10 drives the robot arm 120 to adjust the position of the tool 130, and uses the tool 130 to perform work such as transporting, manufacturing, processing, assembling, and painting a workpiece (work object) 50, for example. The type of tool 130 is not particularly limited, but examples of the tool 130 include a hand that holds the workpiece 50 by gripping, suction, or the like, a processing machine such as a polishing machine, a grinding machine, or a cutting machine, an application device such as a spray gun, and tools such as a screwdriver or a wrench.

In the following, an example will be described in which a rectangular parallelepiped workpiece 50 is disposed on the positive side of the Y-axis direction of the robot 10. Specifically, the surface of the workpiece 50 includes a lower surface 51, an upper surface 52, a first side surface 53a, a second side surface 53b, a third side surface 53c, and a fourth side surface 53d. The lower surface 51 is a flat surface parallel to an X-Y plane. The upper surface 52 is disposed above the lower surface 51 and is a flat surface parallel to the X-Y plane. The first side surface 53a is located between the end portions of the lower surface 51 and the upper surface 52 on the positive side in the Y-axis direction, and is a flat surface parallel to an X-Z plane. The second side surface 53b is located between the end portions of the lower surface 51 and the upper surface 52 on the negative side in the X-axis direction, and is a flat surface parallel to a Y-Z plane. The third side surface 53c is located between the end portions of the lower surface 51 and the upper surface 52 on the negative side in the Y-axis direction, and is a flat surface parallel to the X-Z plane. The fourth side surface 53d is located between the end portions of the lower surface 51 and the upper surface 52 on the positive side in the X-axis direction, and is a flat surface parallel to the Y-Z plane. However, the specific shape and position of the workpiece 50 are not limited to the shape and position shown in the drawing.

In the following, a specific example of the simulation image D1 displayed by the simulation device 30 will be described using a three-dimensional virtual robot 10a simulating the robot 10 and a three-dimensional virtual workpiece 50a simulating the workpiece 50. In this case, for ease of description, the same names and reference numerals as the corresponding portions of the robot 10 are given to the respective portions of the virtual robot 10a. Similarly, the same name and the same reference numeral as the corresponding surface of the workpiece 50 are given to each surface of the virtual workpiece 50a.

Next, the control device 20 will be described.

The control device 20 is installed outside the robot 10 as shown in FIG. 1. However, the control device 20 may be built into the base 110 of the robot 10 or the like. The control device 20 has a function of controlling an operation of the robot 10. As shown in FIG. 2, the control device 20 includes a storage section 21, a control section 22, and a communication section 23. These sections are coupled to each other via a bus.

The storage section 21 is configured by memories such as a random access memory (RAM) and a read only memory (ROM). The storage section 21 stores various programs, such as a control program for controlling the operation of the robot 10, and various types of data.

The control section 22 is configured with at least one processor such as a central processing unit (CPU). The control section 22 reads and executes various programs stored in the storage section 21.

The communication section 23 is configured with various interfaces that enable communication with external devices such as the robot 10 and the simulation device 30. The communication section 23 transmits and receives information and signals to and from external devices. The communication by the communication section 23 may be communication via a network such as a local area network (LAN) or the Internet. The communication mode may be wired or wireless.

Next, the simulation device 30 will be described.

In the present embodiment, the simulation device 30 has a function of displaying the simulation image D1 of a three-dimensional virtual space in which three-dimensional virtual objects such as the virtual robot 10a and the virtual workpiece 50a are disposed, and a function of teaching the robot 10 how to operate. That is, the simulation device 30 also serves as a teaching device in the present embodiment. However, the simulation device 30 may be a device separate from the teaching device.

The simulation device 30 is configured by a computer such as, for example, a personal computer, a tablet, a smartphone, or a teaching pendant. As shown in FIGS. 1 and 2, the simulation device 30 includes a storage section 31, a processing section 32, a communication section 33, a display section 34, and an input section 35. These sections are coupled to each other via a bus.

The storage section 31 is configured by memories such as a RAM and a ROM. The storage section 31 stores various programs such as an operation teaching program of the robot 10 and a display program of the simulation image D1 and various types of data such as three-dimensional shape data of the virtual space. Hereinafter, the display program of the simulation image D1 will also be referred to as a “simulator”. The simulator and the three-dimensional shape data may be stored not in the storage section 31 but in an external memory such as a Universal Serial Bus (USB), or in a server such as an external physical server or cloud server.

The communication section 33 is configured with various interfaces that enable communication with external devices such as the control device 20. The communication section 33 transmits and receives information and signals to and from external devices. The communication by the communication section 33 may be communication via a network such as a LAN or the Internet. The communication mode may be wired or wireless.

The processing section 32 is configured with at least one processor such as a CPU. The processing section 32 reads and executes various programs stored in the storage section 31.

The display section 34 is configured by a display such as a liquid crystal panel or an organic electro luminescence (EL) panel. The display section 34, the details of which will be described later, displays a display screen for the simulation image D1 (see FIGS. 4-5, and 8-10, ), a simulator setting screen D2 (see FIG. 6), a Click Point setting screen D3 (see FIG. 7), and the like, when necessary.

The input section 35 is configured with, for example, a keyboard, a touchpad, a mouse, and the like. The user can operate the input section 35 to input or select desired information. The display section 34 may be configured as a touch panel, and the display section 34 may also have the function of the input section 35. Although details will be described later, the user operates the input section 35 to instruct the movement and rotation of the viewpoint camera Cm, select the method for setting the position of the rotation center Rp displayed on the display section 34, switch or change the display screen, and the like. However, the switching or change of the display screen may be performed automatically by the processing section 32.

Here, a function of the simulation device 30 to display the simulation image D1 of the three-dimensional virtual space will be described in detail. As shown in FIG. 2, the processing section 32 includes an acquisition section 32a, a display control section 32b, and a reception section 32c.

As described above, the storage section 31 stores three-dimensional shape data of the virtual space. The three-dimensional shape data of the virtual space is data that indicates the three-dimensional shapes of each virtual object, such as the virtual robot 10a and the virtual workpiece 50a, which are disposed in the virtual space, and the relative positional relationship between these objects. Examples of three-dimensional shape data in the virtual space include, but are not particularly limited to, computer aided design (CAD) data and building information modeling (BIM) data.

In the three-dimensional shape data of the virtual space, a world coordinate system (Xw, Yw, Zw) is set for the virtual space, as shown in FIGS. 3 and 4. The world coordinate system (Xw, Yw, Zw) is a reference coordinate system when defining the relative positional relationships of all virtual objects that are present in a virtual space. The world coordinate system (Xw, Yw, Zw) is constituted by an origin Ow and three axes Xw, Yw, and Zw, which are orthogonal to each other. In the present embodiment, the user can dispose a virtual object at any position in the virtual space. Therefore, the relative positional relationship between the origin Ow of the world coordinate system (Xw, Yw, Zw) and the virtual object is also optional.

When the user starts the simulator by operating the input section 35, the processing section 32 displays an application window including a start-up screen of the simulator on the display section 34. Note that the start-up screen is not shown. Next, the user operates the input section 35 on a predetermined operation screen in the application window to instruct the display section 34 to display the simulation image D1 of the desired virtual space. Accordingly, the acquisition section 32a acquires three-dimensional shape data of the designated virtual space from the storage section 31.

As shown in FIG. 3, the display control section 32b sets a viewpoint Vp, a line-of-sight direction Vd for viewing the virtual space from the viewpoint Vp, and a field of view Fv, which is an area to be displayed as the simulation image D1 on the display section 34, for the virtual space acquired by the acquisition section 32a. This corresponds to disposing a virtual viewpoint camera Cm having a certain field of view Fv in the virtual space such that the virtual viewpoint camera Cm faces the position of the viewpoint Vp in the line-of-sight direction Vd. Then, when the virtual space is viewed from the viewpoint Vp in the line-of-sight direction Vd, the display control section 32b displays the portion of the virtual space that is within the area of the field of view Fv on the display section 34 as the simulation image D1.

Specifically, for example, the display control section 32b sets a planar projection plane Sc that is orthogonal to the line-of-sight direction Vd and located in front of the viewpoint Vp in the line-of-sight direction Vd within the area of the field of view Fv. In addition, the display control section 32b sets a camera coordinate system (Xc, Yc, Zc) with the viewpoint Vp as an origin Oc, three mutually orthogonal axes Xc, Yc, and Zc, and the axis Zc, which is one of these axes, aligned with the line-of-sight direction Vd. The display control section 32b also sets a projection plane coordinate system (Xs, Ys) that has an origin on the projection plane Sc and is configured by two axes Xs and Ys that are parallel to the projection plane Sc and orthogonal to each other. The camera coordinate system (Xc, Yc, Zc), the projection plane Sc, and the projection plane coordinate system (Xs, Ys) correspond to the viewpoint camera Cm.

Then, the display control section 32b converts the coordinates in the world coordinate system (Xw, Yw, Zw) of each point constituting the virtual object within the range of the field of view Fv into coordinates in the camera coordinate system (Xc, Yc, Zc). Furthermore, the display control section 32b converts the coordinates of each point in the camera coordinate system (Xc, Yc, Zc) into coordinates in the projection plane coordinate system (Xs, Ys). That is, the coordinates of each point in the camera coordinate system (Xc, Yc, Zc) are projected onto the projection plane Sc. The display control section 32b plots the projected coordinates of each point in a predetermined display area (viewport) in the simulator application window displayed on the display section 34, taking into account three-dimensional depth. An image plotted in this viewport corresponds to the simulation image D1.

For example, as shown in FIG. 3, when the viewpoint Vp is located at a first position P1, the line-of-sight direction Vd is directed from the viewpoint Vp toward the edge between the first side surface 53a and the second side surface 53b of the virtual workpiece 50a, and the entire virtual workpiece 50a is contained within the field of view Fv, the display control section 32b creates a simulation image D1 in which the first side surface 53a and the second side surface 53b face forward and the entire virtual workpiece 50a is displayed, as shown in FIG. 5, and displays the simulation image D1 on the display section 34.

The specific method for generating the simulation image D1 is not limited to the method using the coordinate conversion described above and shown in the drawing. For example, the position and the shape of the projection plane Sc are not limited to those shown in the drawing, and the projection plane Sc may be disposed behind the viewpoint Vp. Furthermore, for example, the specific shape of the field of view Fv is not limited to the shape shown in the drawing. Further, the virtual space in the simulation image D1 may be represented using perspective projection or parallel projection. In addition, for example, by operating the input section 35, the display control section 32b can enlarge or reduce the field of view Fv without changing the viewpoint Vp and the line-of-sight direction Vd, that is, can set the vertical and horizontal angles of view on the display section 34 to any desired values.

In the initial state, the display control section 32b sets the viewpoint Vp and the line-of-sight direction Vd such that all virtual objects in the virtual space, that is, the virtual robot 10a and the virtual workpiece 50a, are contained within the field of view Fv, and displays, on the display section 34, the simulation image D1 when the virtual space is viewed from the viewpoint Vp in the line-of-sight direction Vd. Therefore, in the initial state, both the virtual robot 10a and the virtual workpiece 50a are displayed in the simulation image D1, as shown in FIG. 4. Note that the viewpoint Vp and the line-of-sight direction Vd in the initial state are not shown in FIG. 3. However, the method for setting the viewpoint Vp and the line-of-sight direction Vd in the initial state is not limited to the above.

The display control section 32b moves the viewpoint Vp, the line-of-sight direction Vd, and the field of view Fv in the virtual space in response to an operation of the input section 35 by the user. Furthermore, the display control section 32b enlarges and reduces the virtual space in the simulation image D1 in response to an operation of the input section 35 by the user. For example, the simulation image D1 in FIG. 5 is an enlarged view of the virtual workpiece 50a, in which the viewpoint Vp, the line-of-sight direction Vd, and the field of view Fv are moved such that the virtual workpiece 50a in the virtual space is disposed at the center of the field of view Fv.

In addition, as shown in FIG. 3, the display control section 32b rotates the viewpoint Vp, the line-of-sight direction Vd, and the field of view Fv relative to the virtual space around the rotation center Rp in response to an operation of the input section 35 by the user, and changes the display of the virtual space in the simulation image D1 as shown in FIGS. 8 and 9. Hereinafter, rotating the viewpoint Vp, the line-of-sight direction Vd, and the field of view Fv will also be referred to as “rotating the viewpoint camera Cm”. In the present embodiment, rotating the viewpoint camera Cm corresponds to moving and rotating the camera coordinate system (Xc, Yc, Zc), the projection plane coordinate system (Xs, Ys), and the projection plane Sc described above.

Specifically, as shown in FIG. 3, it is assumed that the viewpoint Vp is disposed at the first position P1, the line-of-sight direction Vd extends from the viewpoint Vp toward the edge between the first side surface 53a and the second side surface 53b, and the entire virtual workpiece 50a is contained within the field of view Fv. In this case, as shown in FIG. 8, the entire virtual workpiece 50a is displayed in the simulation image D1 in a state in which the first side surface 53a and the second side surface 53b face forward.

Next, the rotation center Rp is set on the upper surface 52 of the virtual workpiece 50a, and it is assumed that, in response to an operation of the input section 35 by the user, the display control section 32b receives an instruction to rotate the viewpoint camera Cm around the rotation center Rp by an angle corresponding to the amount of operation of the input section 35, as shown in FIG. 3. In this case, the display control section 32b rotates the viewpoint camera Cm around the rotation center Rp on the upper surface 52 by an angle corresponding to the amount of operation. Accordingly, the viewpoint camera Cm moves to a second position P2 on the surface of a sphere whose center is the rotation center Rp and whose radius is the straight line connecting the viewpoint Vp and the rotation center Rp.

In a state in which the viewpoint Vp is disposed at the second position P2, the entire virtual workpiece 50a is contained within the field of view Fv, and the line-of-sight direction Vd extends from the viewpoint Vp toward the center of the second side surface 53b. Therefore, after the viewpoint camera Cm has rotated, the virtual workpiece 50a is displayed in the simulation image D1 in a state in which the second side surface 53b faces forward, as shown in FIG. 9. Note that, when the viewpoint camera Cm is rotated, the virtual space in the simulation image D1 rotates continuously or stepwise from an orientation corresponding to the first position P1 to an orientation corresponding to the second position P2. However, the virtual space in the simulation image D1 may not rotate continuously or stepwise, but may be switched from the orientation corresponding to the first position P1 (see FIG. 8) to the orientation corresponding to the second position P2 (see FIG. 9).

In other words, by operating the input section 35, the user can rotate the virtual space including virtual objects such as the virtual workpiece 50a in the simulation image D1 by any rotation angle in any direction including a roll direction, a pitch direction, and a yaw direction.

The operation of the input section 35 when rotating the viewpoint camera Cm differs depending on the configuration of the input section 35 and is not particularly limited, but examples thereof include the following operations. When the input section 35 is a mouse or a touchpad, the cursor 34b can be moved by moving the mouse, rotating a wheel provided on the mouse, sliding a finger on the touchpad, and the like. Furthermore, when the input section 35 is a keyboard, the operations include pressing a predetermined key such as an arrow key, inputting a predetermined command to rotate a predetermined amount in a predetermined direction, and the like. Furthermore, when the input section 35 is configured with a mouse or a touchpad and a keyboard, an example of an operation includes moving the cursor 34b while pressing a predetermined key on the keyboard. Furthermore, when the input section 35 is a touch panel, operations such as flicking and swiping can be used.

For example, in FIG. 8, the cursor 34b is moved from the right side to the left side of the display section 34. The movement direction of the cursor 34b corresponds to the rotation direction of the viewpoint camera Cm, and the amount of movement of the cursor 34b corresponds to the rotation angle of the viewpoint camera Cm. Specifically, as shown in FIG. 3, in a plan view, the viewpoint camera Cm rotates counterclockwise with an axis a1 that passes through the rotation center Rp and is generally parallel to the Zw-axis direction, as a rotation axis, by a rotation angle proportional to the amount of movement of the cursor 34b. As a result, as shown in FIGS. 8 and 9, in the simulation image D1, the virtual space including the virtual workpiece 50a rotates clockwise with the axis a1 as a rotation axis. In this way, the viewpoint camera Cm moves in the direction opposite to the movement direction of the cursor 34b. Accordingly, the user can rotate the viewpoint camera Cm with the same sensation as rotating a virtual object on which the user is focusing.

In the present embodiment, the method for setting the position of the rotation center Rp can be selected from among a plurality of setting methods. Before describing the types of methods for setting the position of the rotation center Rp, coordinate systems other than the world coordinate system (Xw, Yw, Zw) in the virtual space will be described. In the present embodiment, in addition to the world coordinate system (Xw, Yw, Zw) described above, a local coordinate system (Xl, Yl, Zl) and a tool coordinate system (Xt, Yt, Zt) are further set as shown in FIGS. 3 and 4.

The local coordinate system (Xl, Yl, Zl) is a coordinate system based on a virtual object. Therefore, when a virtual object is moved relative to the origin Ow of the world coordinate system (Xw, Yw, Zw), the local coordinate system (Xl, Yl, Zl) also moves in conjunction with the virtual object. In the present specification, when a specific reference object such as a virtual object is designated as “B” and the expression “a coordinate system based on B” is used, it means that the position of the origin of the coordinate system and the attitude of the coordinate system are set to be in conjunction with B, and the origin of the coordinate system does not necessarily have to be located on B. Therefore, an origin Ol of the local coordinate system (Xl, Yl, Zl) may be on the reference virtual object or may be separated from the reference virtual object.

In the present embodiment, a local coordinate system (Xl, Yl, Zl) is set, which is configured with an origin Ol on the base 110 of the virtual robot 10a and three mutually orthogonal axes Xl, Yl, and Zl. However, the specific position and attitude of the local coordinate system (Xl, Yl, Zl) are not particularly limited to the position and the attitude shown in the drawing. The user may also add another local coordinate system (Xl, Yl, Zl), such as a coordinate system based on the virtual workpiece 50a. Furthermore, when a plurality of virtual robots 10a are disposed in the virtual space, a local coordinate system (Xl, Yl, Zl) may be added for each virtual robot 10a.

The tool coordinate system (Xt, Yt, Zt) is a coordinate system based on the tip end portion of the robot arm 120 of the virtual robot 10a or the tool 130 provided at the tip end portion of the robot arm 120. Therefore, when the virtual robot 10a is operated and the position and the attitude of the tip end portion of the robot arm 120 and the tool 130 change relative to the world coordinate system (Xw, Yw, Zw), the position and the attitude of the tool coordinate system (Xt, Yt, Zt) also change in conjunction with the change. An origin Ot of the tool coordinate system (Xt, Yt, Zt) may be on the tip end portion of the robot arm 120 or on the tool 130, or may be separated from the tip end portion of the robot arm 120 or the tool 130.

In the present embodiment, as shown in FIG. 1, the tip end of the tool 130 attached to the tip end portion of the robot arm 120 is set as a control point TCP, which is the starting point for control of the robot arm 120. As shown in FIGS. 3 and 4, the tool coordinate system (Xt, Yt, Zt) is set, with the control point TCP as the origin Ot, three mutually orthogonal axes Xt, Yt, and Zt, and the axis Yt, which is one of these axes, extending along the longitudinal direction of the tool 130. However, the position and the attitude of the tool coordinate system (Xt, Yt, Zt) are not particularly limited to the position and the attitude shown in the drawing. Additionally, the user may add another tool coordinate system (Xt, Yt, Zt) depending on the type of tool 130 that can be attached to the tip end portion of the robot arm 120. Alternatively, the tool 130 may not be attached to the virtual robot 10a, and the tip end of the arm 126 may be set as the origin Ot of the tool coordinate system (Xt, Yt, Zt).

In the present embodiment, the world coordinate system (Xw, Yw, Zw), the local coordinate system (Xl, Yl, Zl), and the tool coordinate system (Xt, Yt, Zt) are displayed in the simulation image D1 when located within the area of the field of view Fv. However, none of these coordinate systems may be displayed in the simulation image D1, or only one or two of these coordinate systems may be displayed. Furthermore, it may be possible to select whether or not to display each coordinate system in the simulation image D1 in response to an operation of the input section 35 by the user.

As shown in FIGS. 4 and 5, the application window including the simulation image D1 is provided with a setting button B1. When the user presses the setting button B1 by operating the input section 35, the reception section 32c displays a plurality of methods for setting the position of the rotation center Rp on the display section 34, as shown in FIG. 6, and receives the selection of the method for setting the position of the rotation center Rp from among the plurality of setting methods.

Specifically, the reception section 32c displays a simulator setting screen D2 on the display section 34. In this case, the simulator setting screen D2 may be displayed on the simulation image D1. The simulator setting screen D2 includes a setting field for the viewpoint camera Cm. In the setting field for the viewpoint camera Cm, the user can operate the input section 35 to select the method for setting the position of the rotation center Rp and whether or not to display a marker indicating the rotation center Rp in the simulation image D1.

In the present embodiment, the reception section 32c displays four types of setting methods of “World”, “Click Point”, “Local”, and “Tool”, as methods for setting the position of the rotation center Rp, in the setting field for the viewpoint camera Cm, in a pull-down menu format. “World” corresponds to a first setting method in which the origin Ow of the world coordinate system (Xw, Yw, Zw) is set as the position of the rotation center Rp. “Click Point” corresponds to a second setting method for setting the position of the rotation center Rp in response to an operation of the input section 35 by the user. “Local” corresponds to a third setting method in which the origin Ol of the local coordinate system (Xl, Yl, Zl) is set as the position of the rotation center Rp. “Tool” corresponds to a fourth setting method in which the origin Ot of the tool coordinate system (Xt, Yt, Zt) is set as the position of the rotation center Rp.

The user selects the method for setting the position of the rotation center Rp in response to an operation of the input section 35, such as by positioning the cursor 34b on the desired setting method from the pull-down menu and clicking. However, the display and the selection format of the plurality of methods for setting the position of the rotation center Rp are not limited to the pull-down menu format. For example, a plurality of setting methods may be arranged, and check boxes, radio buttons, or the like that allow the user to select whether to enable or disable each setting method may be displayed in parallel.

In the present embodiment, the simulator setting screen also displays a check box for selecting whether or not to display a marker indicating the rotation center Rp. When the user checks the check box by operating the input section 35, a marker is displayed when rotating the viewpoint camera Cm in the simulation image D1, and when the user does not check the check box, the marker can be hidden in the simulation image D1. Therefore, when the user desires to check the position of the rotation center Rp, the user enables the display of the marker. Accordingly, the user can easily check the position of the rotation center Rp, making it easier to operate the input section 35 for rotating the viewpoint camera Cm. On the other hand, when the display of the marker for the rotation center Rp is an obstacle, the user disables the display of the marker. Accordingly, the user can easily check the surface, edges, and the like of the virtual object on which the user is focusing. As shown in FIG. 8, in the present embodiment, the marker indicating the rotation center Rp is a hollow circle.

However, the selection format for whether or not to display a marker is not limited to the check box format. For example, whether to enable or disable the display of the marker may be selected using a pull-down menu format or a radio button. Further, it is not necessary to be able to select whether or not to display the marker. For example, the marker may always be displayed at all times when the viewpoint camera Cm is rotated. Also, for example, the marker may not always be displayed. Further, the specific shape, color scheme, and other appearance of the marker are not limited to those described above.

When the setting of the viewpoint camera Cm is completed, the user operates the input section 35 to press a close button B2 (see FIG. 6). Accordingly, the reception section 32c closes the simulator setting screen D2 while maintaining the settings.

When World is selected by operating the input section 35, the display control section 32b performs setting such that the rotation center Rp is located at the origin Ow of the world coordinate system (Xw, Yw, Zw).

When Local is selected by operating the input section 35, the display control section 32b performs setting such that the rotation center Rp is located at the origin Ol of the local coordinate system (Xl, Yl, Zl). When there are a plurality of local coordinate systems (Xl, Yl, Zl), the reception section 32c may display, on the display section 34, a screen for receiving a selection of which local coordinate system (Xl, Yl, Zl) to use.

When Tool is selected by operating the input section 35, the display control section 32b performs setting such that the rotation center Rp is located at the origin Ot of the tool coordinate system (Xt, Yt, Zt). In addition, when there are a plurality of tool coordinate systems (Xt, Yt, Zt), the reception section 32c may display, on the display section 34, a screen for receiving the selection of which tool coordinate system (Xt, Yt, Zt) to use.

In addition, after the rotation center Rp has been set but before a rotation instruction is received by operating the input section 35, when the origin (rotation center Rp) of the selected coordinate system is located outside the range of the field of view Fv, that is, when the origin of the selected coordinate system is not displayed in the current simulation image D1, the display control section 32b may reset the line-of-sight direction Vd in a direction from the viewpoint Vp toward the rotation center Rp. Here, “setting the line-of-sight direction Vd in a direction from the viewpoint Vp toward the rotation center Rp” includes not only a case where the line-of-sight direction Vd extends strictly along the straight line connecting the viewpoint Vp and the rotation center Rp, as shown in FIG. 3, but also a case where the line-of-sight direction Vd is inclined from this straight line but the rotation center Rp is contained within the field of view Fv. After resetting the line-of-sight direction Vd, the display control section 32b may then rotate the viewpoint camera Cm around the set origin as the rotation center Rp. However, the line-of-sight direction Vd may not be reset. Similarly, when the origin (rotation center Rp) of the selected coordinate system is located outside the range of the field of view Fv, as described above, the field of view Fv can be enlarged to a desired magnification (the angle of view can be widened) without changing the viewpoint Vp and the line-of-sight direction Vd, so that the origin (rotation center Rp) of the selected coordinate system is displayed in the simulation image D1.

When “Click Point” is selected by operating the input section 35, the display control section 32b sets the position of the rotation center Rp in response to the operation of the input section 35 by the user. Therefore, the user can set the rotation center Rp at any position.

Specifically, in the present embodiment, when Click Point is selected and the close button B2 is pressed, the display control section 32b displays a Click Point setting screen D3 on the display section 34, as shown in FIG. 7. On the Click Point setting screen D3, it is possible to select whether to enable either “object priority” or “distance priority from viewpoint camera Cm”. Specifically, the item “object priority” and the item “distance priority from viewpoint camera Cm” are displayed vertically, and check boxes for each item are displayed horizontally. The user operates the input section 35 to check the check box of the item that the user desires to enable.

In a case where object priority is enabled, as shown in FIG. 8, when a virtual object is present directly below the cursor 34b in the simulation image D1, the rotation center Rp is set on the surface of the virtual object. At this time, the display mode may be changed, such as by changing the color scheme of the surface of the virtual object directly below the cursor 34b. Accordingly, the user can easily understand which surface has been selected.

Furthermore, even in a case where object priority is selected, when a virtual object is not present directly below the cursor 34b in the simulation image D1 as shown in FIG. 10, the rotation center Rp is set at a position separated from the viewpoint Vp by a predetermined distance ΔL on a straight line passing through the viewpoint Vp and a position P3 corresponding to the cursor 34b on the projection plane Sc, as shown in FIG. 3. This predetermined distance ΔL may be a fixed value set by the manufacturer of the simulation device 30, or may be a set value that can be freely changed by the user. In the present embodiment, as shown in FIG. 7, the value of “distance from viewpoint camera Cm to rotation center Rp” is displayed on the Click Point setting screen D3, and this value corresponds to the predetermined distance ΔL. The user can change the value of “distance from viewpoint camera Cm to rotation center Rp”, that is, the value of the predetermined distance ΔL, by operating the input section 35. In FIG. 7, for simplicity, the value of the distance from the viewpoint camera Cm to the rotation center Rp is indicated by “***”, but in reality, a specific numerical value is written.

Furthermore, when priority of the distance from the viewpoint camera Cm is enabled, regardless of whether or not a virtual object is present directly below the cursor 34b, the rotation center Rp is set at a position separated from the viewpoint Vp by a predetermined distance ΔL on a straight line connecting the viewpoint Vp and the position corresponding to the cursor 34b on the projection plane Sc.

When the Click Point setting is completed, the user operates the input section 35 to press a close button B3, as shown in FIG. 7. Accordingly, the Click Point setting screen D3 is closed and the simulation image D1 is displayed.

Next, the user operates the input section 35 to actually instruct the rotation of the viewpoint camera Cm. Specifically, the cursor 34b is moved while pressing a predetermined key. Then, based on the position of the cursor 34b immediately before the instruction to rotate the viewpoint camera Cm and the settings of the Click Point described above, the display control section 32b determines the position of the rotation center Rp. Then, the viewpoint camera Cm is rotated by an angle corresponding to the amount of operation of the input section 35 by the user, that is, the amount of movement of the cursor 34b, and the display of the virtual space in the simulation image D1 is changed.

However, the specific method for setting the position of the rotation center Rp at the Click Point is not limited to the above methods. For example, when a virtual object is present directly below the cursor 34b, the rotation center Rp may be set at the center point of the virtual object or the midpoint between the virtual object and the viewpoint Vp. Furthermore, for example, when a plurality of virtual objects are present under the cursor 34b, the rotation center Rp may be set at the midpoint between the viewpoint Vp and the virtual object farthest from the viewpoint Vp among these virtual objects. Furthermore, it is not necessary to be able to select whether to prioritize the object or prioritize the distance from the viewpoint camera Cm. That is, the Click Point setting screen D3 may not be displayed. In this case, the priority may always be given to the object, or the priority may always be given to the distance from the viewpoint camera Cm. Also, for the Click Point, the display control section 32b may reset the line-of-sight direction Vd in a direction from the viewpoint Vp toward the rotation center Rp, and then rotate the viewpoint camera Cm.

This simulation image D1 is displayed during the teaching step of creating operations to be performed by the robot 10, such as when creating point data showing a trajectory such as a control point TCP when operating the robot 10, or when simulating operations based on the created point data on the virtual robot 10a in a virtual space. Here, the point data refers to data including a point on the trajectory such as the control point TCP, that is, a teaching point for the robot 10.

For example, there are cases where the user desires to designate a specific point on the surface or the edge of a virtual object such as the virtual workpiece 50a as a teaching point to be included in the point data of the control point TCP. In such cases, it is preferable that the user can rotate the virtual object in the simulation image D1 and finely adjust the orientation of the virtual object in the simulation image D1 such that the desired surface or edge of the virtual object is displayed in the simulation image D1.

Incidentally, the display control section 32b rotates the viewpoint camera Cm around the rotation center Rp by a rotation angle proportional to the amount of operation of the input section 35 by the user. Therefore, the farther the virtual object to be rotated in the simulation image D1 is from the rotation center Rp, the greater the amount of rotation of the virtual object in the simulation image D1 becomes, even with the same amount of operation. For example, in FIG. 11, when the rotation center Rp is located on the virtual workpiece 50a, the entire virtual workpiece 50a is contained within the field of view Fv both before and after the rotation of the viewpoint camera Cm. On the other hand, when the virtual workpiece 50a is separated from the rotation center Rp, the entire virtual workpiece 50a is contained within the field of view Fv before rotation of the viewpoint camera Cm, but after the rotation, only a portion of the virtual workpiece 50a is contained within the field of view Fv. In this way, the farther the virtual object to be rotated is from the rotation center Rp, the more difficult it is to finely control the orientation of the virtual object in the simulation image D1.

Therefore, when the rotation center Rp is always located at the origin Ow of the world coordinate system (Xw, Yw, Zw), depending on the distance between the origin Ow and the virtual robot 10a or the virtual workpiece 50a, it is difficult to finely adjust the orientation of the virtual object in the simulation image D1. As described above, the relative positional relationship between the origin Ow and the virtual robot 10a or the virtual workpiece 50a is determined freely depending on how the user disposes the virtual robot 10a or the virtual workpiece 50a in the virtual space, and the distance between the origin Ow and the virtual robot 10a or the virtual workpiece 50a may be relatively large.

In contrast to this, in the present embodiment, the user can set the rotation center Rp at any position using the “Click Point”. Therefore, even when the virtual object in focus is separated from the origin Ow, the rotation center Rp can be set on or near the virtual object in focus. Accordingly, the user can efficiently and easily rotate the virtual object on which the user is focusing.

On the other hand, in order to find the position of the next teaching point to be included as point data, it may be desired to change the orientation of the virtual robot 10a and the virtual workpiece 50a while displaying the virtual robot 10a and the virtual workpiece 50a as a whole in the simulation image D1. In this way, in a case where it is desired to display and rotate a plurality of virtual objects in their entirety, when World is selected, the user does not need to operate the input section 35 to specifically designate the position of the rotation center Rp, which simplifies the operation.

Furthermore, for example, in a case where it is desired to focus on a specific virtual object such as the virtual robot 10a in the simulation image D1 and rotate that virtual object, when Local is selected, the user does not need to operate the input section 35 to specifically designate the position of the rotation center Rp, which simplifies the operation. Also, for example, in a case where it is desired to focus on the vicinity of the control point TCP of the robot arm 120 in the simulation image D1 and rotate that vicinity, when Tool is selected, the user does not need to operate the input section 35 to specifically designate the position of the rotation center Rp, which simplifies the operation.

In this way, in addition to Click Point, it is also possible to set the origin of the coordinate system as the rotation center Rp by selecting World, Local, Tool, and the like. Accordingly, the user can select a more appropriate method for setting the position of the rotation center Rp, taking into consideration the object to be rotated, the degree of adjustment of the required amount of rotation, ease of operation, and the like.

Next, a display method according to the present embodiment will be described.

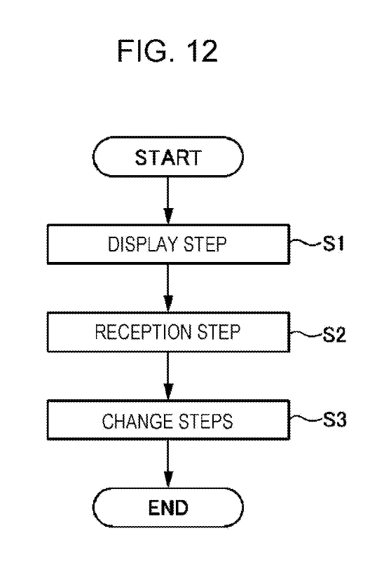

FIG. 12 is a flowchart showing a display method according to the present embodiment.

The display method according to the present embodiment, when outlined with reference to FIG. 12, includes a display step S1, a reception step S2, and a change step S3. Each step will be described in detail below.

First, the user operates the input section 35 to start the simulator. Accordingly, the processing section 32 displays an application window including the simulator start-up screen on the display section 34. Next, the user operates the input section 35 on a predetermined operation screen in the application window to instruct the display section 34 to display the simulation image D1 of the desired virtual space. Accordingly, the acquisition section 32a acquires three-dimensional shape data of the designated virtual space from the storage section 31. Next, a display step S1 is performed.

In the display step S1, the display control section 32b executes a process of setting a viewpoint Vp and a line-of-sight direction Vd for the virtual space acquired by the acquisition section 32a, and displaying, on the display section 34, a simulation image D1 when the virtual space is viewed from the viewpoint Vp in the line-of-sight direction Vd. As described above, in the initial state, the display control section 32b sets the viewpoint Vp and the line-of-sight direction Vd such that all virtual objects in the virtual space are contained within the field of view Fv. Therefore, in the initial state, both the virtual robot 10a and the virtual workpiece 50a are displayed in the simulation image D1, as shown in FIG. 4.

Next, the user can operate the input section 35 to move the viewpoint camera Cm, enlarge or reduce the virtual space in the simulation image D1, rotate the viewpoint camera Cm, and the like. In particular, when rotating the viewpoint camera Cm, the user operates the input section 35 to press the setting button B1 in the application window as shown in FIG. 5. Accordingly, the reception step S2 is performed.

In the reception step S2, the reception section 32c executes a process of displaying, on the display section 34, a plurality of setting methods for setting the position of the rotation center Rp in the virtual space, and receiving a selection of a setting method for the position of the rotation center Rp from among the plurality of displayed setting methods. In the present embodiment, as described above, the simulator setting screen D2 in FIG. 6 is displayed. In the simulator setting screen D2, four types of setting methods of “World”, “Click Point”, “Local”, and “Tool” are displayed in a pull-down menu format as methods for setting the position of the rotation center Rp. The user operates the input section 35 to select a desired setting method from among these four types of setting methods. Therefore, the user can select an appropriate method for setting the position of the rotation center Rp from among the plurality of methods for setting the position of the rotation center Rp presented, taking into consideration the object to be rotated, the degree of adjustment of the required amount of rotation, ease of operation, and the like.

The reception section 32c also receives a selection as to whether or not to display a marker indicating the rotation center Rp in the simulation image D1. The user operates the input section 35 to select whether or not to display a marker indicating the rotation center Rp in the simulation image D1.

Next, the user presses the close button B2 on the simulator setting screen D2. When there are additional settings, such as the settings of the Click Point, the reception section 32c displays a screen for receiving the additional settings, such as the Click Point setting screen D3 shown in FIG. 7. Once all the settings have been completed, the change step S3 is performed.

In the change step S3, as shown in FIGS. 3, 8, and 9, the display control section 32b sets the position of the rotation center Rp based on the selected setting method, and rotates the viewpoint camera Cm around the rotation center Rp in response to the operation of the input section 35, thereby changing the display of the virtual space in the simulation image D1. The user selects an appropriate method for setting the position of the rotation center Rp from the plurality of methods for setting the position of the rotation center Rp presented, taking into consideration the object to be rotated, ease of operation, and the like, and can therefore efficiently acquire the desired simulation image D1.

Note that a device to which the display method, the simulator, and the simulation device 30 according to the present embodiment are applied is not limited to the robot 10. For example, the application target devices may be various vehicles such as automobiles, airplanes, and trains, various machine tools, various sensors, various transport devices, various temperature and humidity adjusting devices, various measuring devices, and the like. In addition, the simulation image D1 may be used to check the shape of these devices, create their operations, simulate the created operations, and simulate various phenomena such as thermodynamic phenomena, fluid dynamic phenomena, material dynamic phenomena, electro-magnetic phenomena, quantum mechanical phenomena, and chemical phenomena in these devices or around the devices.

Furthermore, the plurality of setting methods that the reception section 32c displays on the display section 34 are not particularly limited to the four types of “World”, “Click Point”, “Local”, and “Tool”. For example, the reception section 32c may display only two or only three of these four types of setting methods on the display section 34. In this case, it may be possible to select Click Point and at least one of World, Local, and Tool. In this case, it may be possible to select at least two of World, Local, and Tool without including Click Point. Furthermore, for example, one of the plurality of setting methods that the reception section 32c displays on the display section 34 may be a setting method other than the above four types. For example, when the simulation image D1 is used to simulate various phenomena occurring in the device or around the device, it may be possible to select a setting method in which a coordinate system is set based on the governing factors of these phenomena, and the origin of this coordinate system is set to the position of the rotation center Rp. In addition, for example, the user may register the position of the rotation center Rp in advance. Then, it may be possible to select a setting method for setting the rotation center Rp at the registered position.

For example, the selection of whether or not to display a marker indicating the rotation center Rp in the simulation image D1 may not be performed in the reception step S2. For example, in the change step S3, a button for switching whether or not to display the marker may be provided in the application window, or whether or not to display the marker may be switched when a predetermined key or command is input.

As described above, the display method according to the present embodiment includes a display step S1, a reception step S2, and a change step S3. In the display step S1, the viewpoint Vp and the line-of-sight direction Vd for viewing the virtual space from the viewpoint Vp are set for the three-dimensional virtual space in which the virtual device simulating the device is disposed, and the simulation image D1 when the virtual space is viewed from the viewpoint Vp in the line-of-sight direction Vd is displayed on the display section 34. In the reception step S2, a plurality of setting methods for setting the position of the rotation center Rp in the virtual space are displayed on the display section 34, and a selection of a setting method for the position of the rotation center Rp is received from among the plurality of displayed setting methods. In the change step S3, the position of the rotation center Rp is set based on the selected setting method, and the viewpoint Vp and the line-of-sight direction Vd are rotated around the rotation center Rp in response to the operation of the input section 35, thereby changing the display of the virtual space in the simulation image D1.

Therefore, the user can select a more appropriate method for setting the position of the rotation center Rp from among the plurality of setting methods, taking into consideration the object to be rotated, the degree of adjustment of the required amount of rotation, ease of operation, and the like. Accordingly, the user can efficiently acquire the desired simulation image D1.

One of the plurality of setting methods is a first setting method in which the origin Ow of the world coordinate system (Xw, Yw, Zw) based on the virtual space is set as the position of the rotation center Rp.

Therefore, when the user desires to rotate the entire virtual space in the simulation image D1, the user can rotate the virtual space easily and efficiently by selecting the first setting method.

One of the plurality of setting methods is a second setting method in which the position of the rotation center Rp is set in response to an operation of the input section 35.

Therefore, the user can set the rotation center Rp at any position. Accordingly, the user can easily and efficiently change the rotation of the virtual space at a desired position in the simulation image D1, thereby increasing the degree of freedom in rotation operations.

Further, the device is a robot 10, and one of the plurality of setting methods is a third setting method in which the origin Ol of a local coordinate system (Xl, Yl, Zl) based on the robot 10 is set as the position of the rotation center Rp.

Therefore, when the user desires to rotate the virtual robot 10a in the simulation image D1, the user can rotate the virtual robot 10a easily and efficiently by selecting the third setting method.

Also, the device is a robot 10 having a robot arm 120. One of the plurality of setting methods is a fourth setting method in which the origin Ot of the tool coordinate system (Xt, Yt, Zt) based on the tip end portion of the robot arm 120 or the tool 130 attached to the tip end portion of the robot arm 120 is set as the position of the rotation center Rp.

Therefore, when the user desires to check the orientation of the tip end portion of the robot arm 120 or the tool 130 while changing it in the simulation image D1, the user can easily and efficiently change the orientation of the tip end portion of the robot arm 120 or the tool 130 by selecting the fourth setting method.

One of the plurality of setting methods is a method in which the origin of the coordinate system is set as the position of the rotation center Rp. Another of the plurality of setting methods is a method in which the position of the rotation center Rp is set in response to an operation of the input section 35.

Therefore, when the method of using the origin of the coordinate system as the rotation center Rp is selected, the user does not need to operate the input section 35 to specifically designate the position of the rotation center Rp, which simplifies the operation. On the other hand, in the method of setting the position of the rotation center Rp in response to the operation of the input section 35, the user can set the rotation center Rp at any position. Accordingly, the user can rotate the virtual space at a desired position, thereby increasing the degree of freedom in rotation operations. Therefore, the user can select a more appropriate method for setting the position of the rotation center Rp, taking into consideration the object to be rotated, the degree of adjustment of the required amount of rotation, ease of operation, and the like.

When rotating the viewpoint Vp and the line-of-sight direction Vd, it is possible to select whether or not to display a marker indicating the rotation center Rp in the simulation image D1.

Therefore, the user can rotate the viewpoint Vp and the line-of-sight direction Vd while checking the position of the rotation center Rp by displaying the marker. Further, in a case where the markers are an obstacle when the user visually recognizes a desired location in the virtual space, the user can hide the markers.

In addition, the device is a robot 10. An operation to set a point on the simulation image D1 as a teaching point for the robot 10 is received.

By using the simulation image D1 when setting a teaching point for the robot 10, the teaching point can be set quickly and efficiently.

Further, in the reception step S2, a plurality of setting methods are displayed in a pull-down menu format.

Therefore, the user can easily check and select from a plurality of setting methods.

Also, the program according to the present embodiment causes the computer to execute a display process, a reception process, and a change process. In the display process, the viewpoint Vp and the line-of-sight direction Vd for viewing the virtual space from the viewpoint Vp are set for the three-dimensional virtual space in which the virtual device simulating the device is disposed, and the simulation image D1 when the virtual space is viewed from the viewpoint Vp in the line-of-sight direction Vd is displayed on the display section 34. In the reception process, a plurality of setting methods for setting the position of the rotation center Rp in the virtual space are displayed on the display section 34, and a selection of a setting method for the position of the rotation center Rp is received from among the plurality of displayed setting methods. In the change process, the position of the rotation center Rp is set based on the selected setting method, and the viewpoint Vp and the line-of-sight direction Vd are rotated around the rotation center Rp, thereby changing the display of the virtual space in the simulation image D1.

Therefore, the user can select an appropriate method for setting the position of the rotation center Rp from among the plurality of setting methods, taking into consideration the object to be rotated, the degree of adjustment of the required amount of rotation, ease of operation, and the like. Accordingly, the user can efficiently acquire the desired simulation image D1.

Also, the simulation device 30 according to the present embodiment includes a display section 34, an input section 35, a display control section 32b, and a reception section 32c. The display control section 32b sets the viewpoint Vp and the line-of-sight direction Vd for viewing the virtual space from the viewpoint Vp for the three-dimensional virtual space in which the virtual device simulating the device is disposed, and displays, on the display section 34, the simulation image D1 when the virtual space is viewed from the viewpoint Vp in the line-of-sight direction Vd. The reception section 32c displays, on the display section 34, a plurality of setting methods for setting the position of the rotation center Rp in the virtual space, and receives a selection of a setting method for the position of the rotation center Rp from among the plurality of displayed setting methods by operating the input section 35. Then, the display control section 32b sets the position of the rotation center Rp based on the selected setting method, and rotates the viewpoint Vp and the line-of-sight direction Vd around the rotation center Rp, thereby changing the display of the virtual space in the simulation image D1.

Therefore, the user can select an appropriate method for setting the position of the rotation center Rp from among the plurality of setting methods presented, taking into consideration the object to be rotated, the degree of adjustment of the required amount of rotation, ease of operation, and the like. Accordingly, the user can efficiently acquire the desired simulation image D1.

Although the display method, the program, and the simulation device according to the present disclosure have been described above with reference to the illustrated embodiments, the present disclosure is not limited to these. Furthermore, each step, each process, and each section of the display method, the program, and the simulation device can be replaced with any step, process, or structure that can exhibit a similar function. In addition, any step, process, or structure may be added.

1. A display method comprising:
a display step of setting, for a three-dimensional virtual space in which a virtual device simulating a device is disposed, a viewpoint and a line-of-sight direction for viewing the virtual space from the viewpoint, and displaying, on a display section, a simulation image when the virtual space is viewed from the viewpoint in the line-of-sight direction;
a reception step of displaying, on the display section, a plurality of setting methods for setting a position of a rotation center in the virtual space, and receiving a selection of the setting method for the position of the rotation center from among the plurality of displayed setting methods; and
a change step of setting the position of the rotation center based on the selected setting method, and rotating the viewpoint and the line-of-sight direction around the rotation center in response to an operation of an input section to change the display of the virtual space in the simulation image.

2. The display method according to claim 1, wherein
one of the plurality of setting methods is a first setting method in which an origin of a world coordinate system based on the virtual space is set as the position of the rotation center.

3. The display method according to claim 1, wherein
one of the plurality of setting methods is a second setting method in which the position of the rotation center is set in response to the operation of the input section.

4. The display method according to claim 1, wherein
the device is a robot, and
one of the plurality of setting methods is a third setting method in which an origin of a local coordinate system based on the robot is set as the position of the rotation center.

5. The display method according to claim 1, wherein
the device is a robot having a robot arm, and
one of the plurality of setting methods is a fourth setting method in which an origin of a tool coordinate system based on a tip end portion of the robot arm or a tool attached to the tip end portion of the robot arm is set as the position of the rotation center.

6. The display method according to claim 1, wherein
one of the plurality of setting methods is a method in which an origin of a coordinate system is set as the position of the rotation center, and
another of the plurality of setting methods is a method in which the position of the rotation center is set in response to the operation of the input section.

7. The display method according to claim 1, wherein
when the viewpoint and the line-of-sight direction are rotated, whether or not to display a marker indicating the rotation center in the simulation image is selectable.

8. The display method according to claim 1, wherein
the device is a robot, and
an operation to set a point on the simulation image as a teaching point for the robot is received.

9. The display method according to claim 1, wherein
in the reception step, the plurality of setting methods are displayed in a pull-down menu format.

10. A non-transitory computer-readable storage medium storing a program, the program causing a computer to execute:
a display process of setting, for a three-dimensional virtual space in which a virtual device simulating a device is disposed, a viewpoint and a line-of-sight direction for viewing the virtual space from the viewpoint, and displaying, on a display section, a simulation image when the virtual space is viewed from the viewpoint in the line-of-sight direction;
a reception process of displaying, on the display section, a plurality of setting methods for setting a position of a rotation center in the virtual space, and receiving a selection of the setting method for the position of the rotation center from among the plurality of displayed setting methods; and
a change process of setting the position of the rotation center based on the selected setting method, and rotating the viewpoint and the line-of-sight direction around the rotation center to change the display of the virtual space in the simulation image.

11. A simulation device comprising:
a display section;
an input section;
a display control section that sets, for a three-dimensional virtual space in which a virtual device simulating a device is disposed, a viewpoint and a line-of-sight direction for viewing the virtual space from the viewpoint, and displays, on the display section, a simulation image when the virtual space is viewed from the viewpoint in the line-of-sight direction; and
a reception section that displays, on the display section, a plurality of setting methods for setting a position of a rotation center in the virtual space, and receives a selection of the setting method for the position of the rotation center from among the plurality of displayed setting methods by operating the input section, wherein
the display control section sets the position of the rotation center based on the selected setting method, and rotates the viewpoint and the line-of-sight direction around the rotation center to change the display of the virtual space in the simulation image.
